(19) United States
(12) Patent Application Publication
(10) Pub. No.: US 2006/0199081 A1
(43) Pub. Date: Sep. 7, 2006

(54) Holographic storage medium, article and method

(75) Inventors: Michael Jeffrey McLaughlin, Albany, NY (US); Christoph Georg Erben, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/073,406

(22) Filed: Mar. 4, 2005

(51) Int. Cl. G03H 1/04

(52) U.S. Cl. 430/1; 430/2; 359/3

(57) ABSTRACT

Disclosed are a holographic storage medium, a method for producing a holographic storage medium, a method for storing data on a holographic storage medium, and an optical reading method. The holographic storage medium comprises an dimensionally stable film that is formed by partially curing a mixture, wherein said mixture comprises (a) a binder material; (b) a curable photoactive material; (c) an optional sensitizer; and (d) a photoinitiator, and wherein at least a portion of the photoactive material remains unreacted after the forming. Articles comprising holographic storage media in various forms are also disclosed.

### BACKGROUND OF THE INVENTION

The present disclosure relates to optical data storage media, and more particularly, to holographic storage media as well as methods of making and using the same.

Holographic storage is data storage of holograms, which are images of three dimensional interference patterns created by the intersection of two beams of light in a photosensitive medium. The superposition of a reference beam and a signal beam containing digitally encoded data forms an interference pattern within the volume of the medium, resulting in a reaction that changes or modulates the refractive index of the medium. This modulation serves to record as the hologram both the intensity and phase information from the signal. The hologram can later be retrieved by exposing the storage medium to the reference beam alone, which interacts with the stored holographic data to generate a reconstructed signal beam proportional to the initial signal beam used to store the holographic image.

Each hologram may contain anywhere from one to 1×10⁶ or more bits of data. One distinct advantage of holographic storage over surface-based storage formats, including CDs or DVDs, is that a large number of holograms may be stored in an overlapping manner in the same volume of the photosensitive medium using a multiplexing technique, such as by varying the signal and/or reference beam angle, wavelength, or medium position. However, a major impediment towards the realization of holographic storage as a viable technique has been the need for development of a reliable and economically feasible storage medium.

Early holographic storage media employed inorganic photorefractive crystals, such as doped or undoped lithium niobate (LiNbO₃), in which incident light creates refractive index changes. These index changes are due to the photo-induced creation and subsequent trapping of electrons leading to an induced internal electric field that ultimately modifies the refractive index through a linear electro-optic effect. However, LiNbO₃ is expensive, exhibits relatively poor efficiency, and requires thick crystals to observe any significant index changes.

More recent work has led to the development of polymers that can sustain larger refractive index changes owing to optically induced polymerization processes. These materials, which are referred to as photopolymers, have significantly improved optical sensitivity and efficiency relative to LiNbO₃ and its variants. In some processes, “single-chemistry” systems have been employed, wherein the media comprise a homogeneous mixture of at least one photoactive polymerizable liquid monomer or oligomer, an initiator, an inert polymeric filler, and optionally a sensitizer. Since it initially has a large fraction of the mixture in monomeric or oligomeric form, the media typically have a gel-like consistency that renders them inconvenient to handle and store.

Other examples of holographic recording media are based on “two-chemistry” systems, wherein a binder or other material that provides the medium with form and stability is different from the photoactive component. These systems comprise a mixture of at least one photoactive polymerizable liquid monomer or oligomer, an initiator, at least one precursor (i.e. monomers or oligomers) to the binder material, and optionally a sensitizer. These mixtures also initially have a gel-like consistency until the precursors to a binder material polymer are cured within a support to provide form and stability to the medium. Problems similar to those described for single-chemistry systems may occur during the binder cure step. The medium, prior to data storage, has a uniform refractive index based on the weight fraction of each component and their individual refractive indices. Polymerization of the photoactive monomers (or oligomers) leads to the formation of a polymer that has a refractive index different from that of the binder material. Photoactive monomer molecules diffuse into the region of polymerization, while binder material diffuses out because it does not participate in the polymerization. Spatial separation of the photopolymer formed from the monomer, and the binder material provides the refractive index modulation required to form a hologram. While better results are obtained using these two-chemistry systems, the possibility exists for reaction between the precursors to the binder material and the photoactive monomer. Such reaction typically reduces the refractive index contrast between the binder material and the polymerized photoactive monomer, thereby affecting any stored holograms.

Holographic storage media materials prior to data storage are typically gel-like substances that are difficult to store and handle. Typical media preparation processes involve sandwiching a viscous photopolymer material between glass slides and curing with UV radiation to harden the media into a useful form. Methods are sought to improve the handling ability of holographic storage media materials. Thus, there remains a need for improved media systems suitable for holographic data storage.

### BRIEF DESCRIPTION OF THE INVENTION

In the present invention it has been unexpectedly discovered that a material in the form of an dimensionally stable film may be formed and used as a holographic storage medium. In contrast to prior art the data storage medium of the present invention in the form of an dimensionally stable film is more convenient to handle and use before and after the data storage.

In one embodiment the invention relates to a method of making a holographic storage medium comprising an dimensionally stable film, said method comprising: forming said dimensionally stable film by partially curing a mixture, wherein said mixture comprises a binder material; a curable photoactive material; an optional sensitizer; and a photoinitiator, and wherein at least a portion of the photoactive material remains unreacted after the forming of the holographic storage medium.

In another embodiment, the invention relates to holographic storage medium comprising: a dimensionally stable film, said dimensionally stable film of said holographic storage medium comprising: a binder material; an unreacted curable photoactive material; an optional sensitizer; and a photoinitiator.

In another embodiment the invention relates to holographic storage medium comprising a dimensionally stable film, wherein (a) the dimensionally stable film is in a sealed transparent mold, or (b) is partially encapsulated by a substrate, wherein said dimensionally stable film and said substrate are optionally joined by an adhesive layer; wherein said transparent mold and said substrate are transparent to radiation of wavelength in the range of from about 300 nanometers to about 900 nanometers, and wherein said transparent mold and said substrate are selected from the group consisting of glass, polycarbonates, polyesters, polyamides, polyolefins, and combinations thereof.

In still another embodiment the invention provides a method of storing data on a holographic storage medium comprising the steps of: (i) forming the holographic storage medium in the form of an dimensionally stable film, said dimensionally stable film formed by partially curing a mixture, said mixture comprising: a binder material; a curable photoactive material; an optional sensitizer; a photoinitiator, and an optional thermal curing catalyst; wherein at least a portion of the photoactive material remains after the partial cure process; wherein the binder material comprises either an inert material; a reaction product of a thermally curable mixture comprising at least one curable monomer; or combinations thereof; wherein the photoactive material comprises one or more epoxide compounds; wherein (a) the curing step to form said dimensionally stable film is performed inside a transparent mold, followed by removing the dimensionally stable film from the mold, or wherein (b) the curing step takes place within a sealed transparent mold, or wherein (c) the dimensionally stable film obtained after a separate curing step may be at least partially encapsulated by a substrate; wherein said dimensionally stable film and said substrate are optionally joined by an adhesive layer; wherein said transparent mold and substrate are transparent to radiation of wavelength in the range of from about 300 nanometers to about 900 nanometers, and wherein said transparent mold and substrate are selected from the group consisting of glass, polycarbonates, polyesters, polyamides, polyolefins, and combinations thereof; and (ii) illuminating the holographic storage medium with both a signal beam containing data and a reference beam, thereby forming within the holographic storage medium an interference pattern, wherein the photoinitiator initiates polymerization of at least a portion of the photoactive material in response to the signal beam and reference beam, resulting in formation of a hologram in the holographic storage medium.

In still another embodiment the invention provides an optical reading method comprising: (i) forming a holographic storage medium comprising an dimensionally stable film, said dimensionally stable film formed by partially curing a mixture, said mixture comprising: a binder material; a curable photoactive material; an optional sensitizer; a photoinitiator, and an optional thermal curing catalyst; wherein at least a portion of the photoactive material remains after the partial cure process; wherein the binder material comprises an inert material; a reaction product of a thermally curable mixture comprising at least one curable monomer; or combinations thereof; wherein the photoactive material comprises one or more epoxide compounds; wherein (a) the curing step to form said dimensionally stable film is performed inside a transparent mold, followed by removing the dimensionally stable film from the mold, or wherein (b) the curing step takes place within a sealed transparent mold, or wherein (c) the dimensionally stable film obtained after the curing step may be at least partially encapsulated by a substrate, wherein said dimensionally stable film and said substrate are optionally joined by an adhesive layer; wherein said transparent mold and substrate are transparent to radiation of wavelength in the range of from about 300 nanometers to about 900 nanometers, and wherein said transparent mold and substrate are selected from the group consisting of glass, polycarbonates, polyesters, polyamides, polyolefins, and combinations thereof; (ii) illuminating the holographic storage medium with both a signal beam containing data and a reference beam, thereby forming within the holographic storage medium an interference pattern, wherein the photoinitiator initiates polymerization of at least a portion of the photoactive material, resulting in formation of a hologram in the holographic storage medium; and (iii) illuminating the holographic storage medium with a read beam effective to read the data contained by diffracted light from the hologram.

In yet still another embodiment the invention also provides an article comprising: a prefabricated transparent mold and a holographic storage medium comprising an uncured mixture, wherein said holographic storage medium is sealed within said transparent mold, said mixture comprising: a binder material; a curable photoactive material; an optional sensitizer; and a photoinitiator.

Various other features, aspects, and advantages of the present invention will become more apparent with reference to the following description and appended claims.

### BRIEF DESCRIPTION OF THE DRAWINGS

FIG. 1 is a schematic representation of a holographic storage process for (a) writing data and (b) reading stored data.

FIG. 2 is a schematic representation of a diffraction efficiency characterization system for (a) writing plane wave holograms and (b) measuring diffracted light.

### DETAILED DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise.

As used herein the term “aliphatic radical” refers to an organic radical having a valence of at least one comprising a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like, provided that the said functional group does not interfere with the curing process of a component of the holographic storage medium. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl; difluorovinylidene; trichloromethyl, bromodichloromethyl, bromoethyl, 2-bromotrimethylene (e.g. —CH₂CHBrCH₂—), and the like. By way of further example, a C₁-C₁₀ aliphatic radical contains at least one but no more than 10 carbon atoms. A methyl group (i.e. CH₃—) is an example of a C₁ aliphatic radical. A decyl group (i.e. CH₃(CH2)₁₀—) is an example of a C₁₀ aliphatic radical.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like, provided that the said functional group does not interfere with the curing process of a component of the holographic storage medium. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as trifluoromethylphenyl, hexafluoroisopropylidenebis(4-phen-1-yloxy) (i.e. —OPhC(CF₃)₂PhO—), chloromethylphenyl; 3-trifluorovinyl-2-thienyl; 3-trichloromethylphen-1-yl (i.e. 3-CCl₃Ph—), 4-(3-bromoprop-1-yl)phen-1-yl (i.e. BrCH₂CH₂CH₂Ph—), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like, provided that the said functional group does not interfere with the curing process of a component of the holographic storage medium. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e. —C₆H₁₀C(CF₃)₂C₆H₁₀—), 2-chloromethylcyclohex-1-yl; 3-difluoromethylenecyclohex-1-yl; 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀—), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

Disclosed herein are optical data storage media and holographic storage media. Also disclosed herein are methods directed to optical data storage media preparation, holographic data storage, and holographic data retrieval. The holographic storage media are generally derived from a mixture comprising a binder material and a photoactive material. The binder material may be either essentially inert or may be derived from a curable monomer or mixture comprising a curable material, wherein the said material is cured in the presence of the photoactive material and is curable by a mechanism different from that curing mechanism of the photoactive material. Curable material for the binder within the present context refers to one or more curable monomers, one or more curable oligomers, or a mixture of a curable monomer and a curable oligomer. In a particular embodiment the invention relates to a dimensionally stable film onto which optical data may be stored through polymerization of the photoactive material present in the film. A “dimensionally stable film” refers to a film that is dimensionally self-supporting and retains its shape when picked up at one edge and held in space for a period of time in the absence of any supports such as spacer plates or substrates. The dimensionally stable film is prepared by forming a solid matrix through a polymerization reaction of a matrix precursor. In one embodiment the photoactive material itself is partially polymerized to form the matrix material wherein at least a portion of photoactive material remains unreacted. In another embodiment a binder material comprising a curable material is at least partially cured to form the matrix material comprising unreacted photoactive material. In still another embodiment a binder material comprising a curable material is essentially completely cured to form the matrix material comprising unreacted photoactive material. The dimensionally stable film is such that it may optionally be subjected to post-formation processing steps such as, but not limited to, handling, shaping, cutting, folding, completely encapsulating or sandwiching it between substrates, and like processes. The dimensionally stable film is subsequently written with holographic interference pattern.

In one embodiment the holographic storage medium, after a partial curing step and prior to data storage, comprises an inert binder material, a photoactive material, and a photoinitiator. In another embodiment the holographic storage medium, after a partial curing step and prior to data storage, comprises a cured binder material, a photoactive material, and a photoinitiator. The curing can be effected by methods known to those skilled in the art. These methods comprise thermal curing, photo curing, microwave curing, and combinations thereof, wherein the term photocuring refers to curing by exposure to any of a variety of wavelengths of radiation, including visible light, IR light, UV light, and x-rays. It is also possible to perform curing by electron or particle beams. In other embodiments the holographic storage medium may optionally comprise a sensitizer and/or a binder curing catalyst.

In one embodiment a binder material is an inert component of the mixture from which holographic storage media are derived. In another embodiment a binder material comprises a reaction product of a curable mixture comprising at least one curable material. Illustrative examples of curing reactions contemplated for forming matrix materials in the invention comprise cationic epoxy polymerization, cationic vinyl ether polymerization, cationic alkenyl ether polymerization, cationic allene ether polymerization, cationic ketene acetal polymerization, epoxy-amine step polymerization, epoxy-mercaptan step polymerization, unsaturated ester-amine step polymerization (via Michael addition), unsaturated ester-mercaptan step polymerization (via Michael addition), vinyl-silicon hydride step polymerization (hydrosilylation), isocyanate-hydroxyl step polymerization (urethane formation), and isocyanate-amine step polymerization (urea formation). In a particular embodiment a binder material is formed from thermally curable polysiloxane compounds that are typically derived from a mixture of silicone monomers and/or oligomers at least one of which comprises an alkenyl functionality and at least one of which comprises a hydride functionality. To produce a suitable thermally cured binder material, the hydride to alkenyl ratio is conveniently taken in the range of 0.5 to 3, preferably in the ratio of 0.5 to 2, and more preferably in the range of 1.0 to 1.75. In some embodiments the silicone monomers and/or oligomers having alkenyl functionalities that may be employed to form the binder material comprise terminal alkenyl siloxanes of the general formula (I): 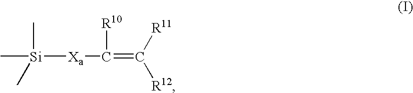
wherein R¹⁰, R¹¹, and R¹² each independently comprise hydrogen or a monovalent aliphatic radical, a monovalent aromatic radical, or a monovalent cycloaliphatic radical; X a divalent aliphatic radical, a divalent aromatic radical, or a divalent cycloaliphatic radical; and ‘a’ is a whole number having a value between 0 and 8, inclusive. In other embodiments the silicone monomers and/or oligomers having alkenyl functionalities that may be employed to form the binder material comprise siloxanes with internal alkenyl functionality and optionally terminal alkenyl functionality, wherein internal functionality is located at sites other than terminal sites. The silicone hydride monomers and/or oligomers are hydrosiloxanes having hydrogen directly bonded to one or more of the silicon atoms, optionally at a terminal site, and therefore contain at least one reactive Si—H functional group.

The physical, optical, and chemical properties of the binder material can be tailored for optimum performance in the recording medium inclusive of, for example, dynamic range, recording sensitivity, image fidelity, level of light scattering, and data lifetime. Suitable polysiloxane binder materials include, but are not intended to be limited to, a poly(dialkylsiloxane); a poly(alkylarylsiloxane); a poly(methylphenylsiloxane); 1,3,5-trimethyl-1,1,3,5,5-pentaphenyltrisiloxane; 1,3,5-trimethyl-1,1,3,5,5-pentaphenyltrisiloxane; an alkenyl-functionalized polysiloxane; a vinyl-terminated poly(dialkylsiloxane); a vinyl-terminated poly(alkylarylsiloxane); a vinyl-terminated poly(methylphenylsiloxane); a reaction product of a hydride-functionalized polysiloxane and an alkenyl-functionalized polysiloxane; a cyclic silicone oligomer; a product derived from a cyclic silicone oligomer; a product derived from divinyltetramethyldisiloxane; and combinations thereof. Other suitable siloxanes will be apparent to those skilled in the art in view of this disclosure. Commercially available siloxane monomers and/or oligomers or a combination thereof can be obtained, for example, from Gelest, Inc.

The optional binder curing catalyst may be used to initiate or promote thermal cure of the thermally curable siloxane material. The binder curing catalyst can be a homogeneous catalyst such as, for example, a metal-complex compound in a carrier agent such as alcohols, xylenes, divinylsiloxanes, cyclic vinylsiloxanes or the like. Specific metal-complex compounds include, but are not limited to, platinum divinyltetramethyldisiloxane, platinum carbonyl cyclovinylmethylsiloxane, platinum cyclovinylmethylsiloxane, platinum octanaldehyde, titanium di-n-butoxide (bis-2,4-pentanedionate), titanium di-isopropoxide (bis-2,4-pentanedionate), titanium di-isopropoxide bis(ethylacetoacetate), titanium 2-ethylhexoxide tetraoctyltitanate, and the like. Another binder curing catalyst, which may be employed is chloroplatinic acid (also referred to as “Speier's catalyst”). Other catalysts include, but are not intended to be limited to, radical hydrosilylation catalysts, such as tributyltin hydride, benzoyl peroxide, and LUPERSOL 101™, the tradename for 2,5-bis(tert-butylperoxy)-2,5-dimethyl hexane available from Atofina Chemicals, and like peroxide or radical precursors.

When thermally cured, the thermal cure of the binder material may occur at a temperature of about 25° C. to about 100° C. When photocured, the photocure of the binder material may be performed at a wavelength in the range outside of the wavelength necessary to write the holographic data. After the optional binder cure step, the holographic storage medium may be subjected to processes known to those skilled in the art for holographic data storage, i.e., portions of the photoactive material are exposed to a suitable light source. Holographic data storage is one of several techniques that may use the full volume of a storage material to maximize data density (as opposed to surface storage as is used in CD and DVD type systems). In the holographic storage process, the data is used to generate an optical interference pattern, which is subsequently stored in the holographic storage medium.

The binder material desirably has sufficient optical quality (e.g., low scatter, low birefringence, and negligible losses at the wavelengths of interest), to render the data in the holographic storage material readable. In addition, the binder material desirably does not inhibit polymerization of the photoactive material. Furthermore, the binder material desirably is capable of withstanding the processing parameters and subsequent storage conditions.

The photoactive material may comprise a monomer, an oligomer, or a combination comprising one of the foregoing materials, capable of undergoing photoinitiated polymerization to form a polymer. For example, cationically polymerizable systems such as, for example, vinyl ethers, alkenyl ethers, allene ethers, ketene acetals, epoxides and like materials are suitable for use in the present disclosure. Other suitable photoactive materials include those which polymerize by a free-radical reaction such as, for example, molecules containing ethylenic unsaturation such as acrylates, methacrylates, methyl methacrylates, acrylamides, methacrylamides, styrene, substituted styrenes, vinyl naphthalene, substituted vinyl naphthalenes, n-vinylcarbazole, other vinyl derivatives, and combinations thereof. Free-radical copolymerizable pair systems are also suitable, e.g., vinyl ethers mixed with maleates, thiols mixed with olefins, and like mixtures.

Suitable epoxide materials include, but are not intended to be limited to, cyclohexene oxide; cyclopentene oxide; 4-vinylcyclohexene oxide; derivatives such as silylethyl derivatives capable of being prepared from 4-vinylcyclohexene oxide; 4-alkoxymethylcyclohexene oxides; acyloxymethylcyclohexene oxides capable of being prepared from 4-hydroxymethylcyclohexenes; polyfunctional epoxides such as 3,4-epoxycyclohexylmethyl-3,4-epoxycyclohexanecarboxylate; 1,3-bis(2-(3,4-epoxycyclohexyl)ethyl)-1,1,3,3-tetramethydisiloxane; 2-epoxy-1,2,3,4-tetrahydronaphthalene; and combinations comprising one or more of the foregoing epoxide materials. A suitable commercially available epoxide is bis-epoxy monomer under the trade name PC-1000 from Polyset Inc.

Other suitable epoxide materials comprise those in which one or more cyclohexene oxide groupings are linked to an Si—O—Si grouping. Examples of such materials include those of the formula (II): 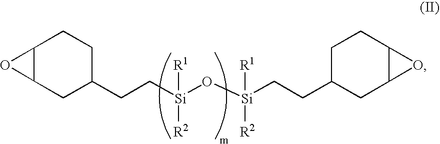
wherein each R¹ and each R² is independently an C₁₋₁₂ aliphatic group, C₁₋₁₂ cycloaliphatic or C₃-C₂₀ aromatic radical; and m is an integer having a value ranging from 1 to 100. In a particular embodiment R¹ and R² are the same and the value of m equals one. In another particular embodiment R¹ and R² are each methyl groups and the value of m equals one

A variety of tri-, tetra- and higher polyepoxysiloxanes may also be employed as the photoactive epoxide material. One group of such polyepoxysiloxanes are the cyclic compounds of formula (III): 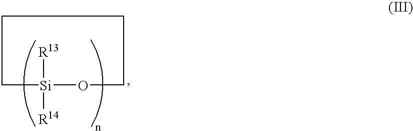
wherein each R¹³ is independently a monovalent C₁₋₁₂ aliphatic radical, C₁₋₁₂ cycloaliphatic radical, or C₃-C₂₀ aromatic radical; each R¹⁴ is independently R¹³ or a monovalent epoxy functional group having 2 to 10 carbon atoms, with the proviso that at least three of the R¹⁴ groups are epoxy functional; and n is an integer having a value of 3 to 10, inclusive. A specific material of this type is 1,3,5,7-tetrakis(2-(3,4-epoxycyclohexyl)ethyl)-1,3,5,7-tetramethylcyclotetrasiloxane.

Other suitable photoactive epoxide materials are represented by:
R⁴Si(OSi(R⁵)₂R⁶)₃
wherein R⁴ is an OSi(R⁵)₂R⁶ grouping, or a monovalent substituted or unsubstituted C₁₋₁₂ aliphatic, C₁₋₁₂ cycloaliphatic, or C₃-C₂₀ aromatic group; each R⁵ is independently a monovalent substituted or unsubstituted C₁₋₁₂ aliphatic, C₁₋₁₂ cycloaliphatic, or C₃-C₂₀ aromatic group; and each R⁶ is independently a monovalent epoxy functional group having 2 to 10 carbon atoms. One specific material is that in which R⁴ is a methyl group or an OSi(R⁵)₂R⁶ grouping; each group R⁵ is a methyl group, and each group R⁶ is a 2-(3,4-epoxycyclohexyl)ethyl grouping.

Other suitable photoactive epoxide materials are represented by:
(R⁷)₃SiO[SiR⁸R⁹O]ₚ[Si(R⁸)₂O]_{q}Si(R⁷)₃
wherein each R⁷ is independently a monovalent substituted or unsubstituted C₁₋₁₂ aliphatic, C₁₋₁₂ cycloaliphatic, or C₃-C₂₀ aromatic group; each R⁸ is independently a monovalent substituted or unsubstituted C₁₋₁₂ aliphatic, C₁₋₁₂ cycloaliphatic, or C₃-C₂₀ aromatic group; each R⁹ is independently a monovalent epoxy functional group having 2 to 10 carbon atoms. Specific materials of this type are those in which each group R⁷ and R⁸ is an aliphatic group, such as, for example, that in which R⁹ is a 2-(3,4-epoxycyclohexyl)ethyl grouping and p and q are about equal. Combinations comprising one or more of the foregoing photoactive materials may also be employed.

Other suitable photoactive epoxide materials are represented by:
R⁹(R⁷)₂SiO[SiR⁸R⁹O]ₚ[Si(R⁸)₂O]_{q}Si(R⁷)₂R⁹
wherein each R⁷ is, independently, a monovalent substituted or unsubstituted C₁₋₁₂ aliphatic, C₁₋₁₂ cycloaliphatic, or C₃-C₂₀ aromatic group; each R⁸ is, independently, a monovalent substituted or unsubstituted C₁₋₁₂ aliphatic, C₁₋₁₂ cycloaliphatic, or C₃-C₂₀ aromatic group; each R⁹ is, independently, a monovalent epoxy functional group having 2 to 10 carbon atoms; p is an integer having a value in a range of between about 1 and about 20; and q is an integer having a value in a range of between about 5 and about 200.

In the holographic storage medium at least a portion of remaining photoactive material can be selectively photopolymerized by exposure to UV light. There is an inhomogeneous region caused by the refractive index difference between the regions of polymerized photopolymer and the regions that do not comprise UV polymerized photopolymer in which the data may be stored. Thus, polymerization of at least a portion of the photoactive material provides an optically readable datum within the holographic storage medium. The information stored in the inhomogeneous region may be reconstructed by shining a single beam of light through the inhomogeneous region.

To provide a holographic medium that exhibits relatively low levels of light scatter, the binder material and photoactive material, as well as any other components, are advantageously compatible. Polymers are considered to be compatible if a blend of the polymers is characterized, in a 90° light scattering experiment using a wavelength used for hologram formation, by a Rayleigh ratio (R_{90°}) less than about 7×10⁻³ cm⁻¹. The Rayleigh ratio is a well-known property, and is defined as the energy scattered by a unit volume in the direction θ (per steradian), when a medium is illuminated with a unit intensity of unpolarized light. The Rayleigh ratio may be obtained by comparison to the energy scatter of a reference material having a known Rayleigh ratio. The compatibility of the binder material with other components, such as the photoactive material, may be increased by appending to the binder material groups that resemble such other components (e.g., a functional group from a photoactive material), or by appending to the binder material a group that displays a favorable enthalpic interaction, such as hydrogen bonding, with such other components. Modifications may be made to various components of a material to increase the overall compatibility of the individual components.

The holographic storage medium also comprises a photoinitiator for inducing polymerization of the photoactive material. Direct light-induced polymerization of the photoactive material by itself, such as by exposure to light may be difficult, particularly as the thickness of storage media increases. The photoinitiator, upon exposure to relatively low levels of the recording light, chemically initiates the polymerization of the photoactive material, avoiding the need for direct light-induced polymerization.

One type of photoinitiator is a photoacid generator that is capable of, or contains a moiety that is capable of, absorbing incident radiation at some wavelength, and, through subsequent chemical transformation, releasing at least one proton, strong protic acid, or Lewis acid. Where a photoacid generator has a low absorbance at a preferred radiation, a sensitizer may optionally be used. Sensitizers absorb, or contain a moiety that absorbs, the incident radiation at the wavelength of interest, and transfer the energy to the photoacid generator (e.g., by way of Forster transfer, electron transfer, or chemical reaction) thereby inducing reaction of the photoacid generator. For example, many photoacid generators respond to UV light, whereas visible light (e.g., 400 to 700 nm) is typically used for recording holograms. Thus, sensitizers that absorb at such visible wavelengths and transfer energy to photoinitiators may be used. Typical sensitizers are aromatic hydrocarbons substituted with at least one alkynyl group, or at least one alkenyl group, and preferably substituted with two alkynyl groups or alkenyl groups. Preferred sensitizers are compounds such as those described in WO0190817A2 and Hua et al., Journal of Polymer Science, volume 38, pages 3697-3709 (2000). Exemplary sensitizers that absorb at visible wavelengths include, but are not limited to, rubrene, 5,12-bis(phenylethynyl)naphthacene, perylene, N-vinyl carbazole, N-phenyl carbazole, and combinations thereof.

In another embodiment the photoacid generator may have a sensitizer moiety, or the released proton or acid may originate with the sensitizer. For example, the photoacid generator and sensitizer may be covalently bonded. Such a covalently bound photoacid generator/sensitizer, however, would be extremely sensitive to the radiation absorbed by the sensitizer. In other embodiments the photoacid generator and/or sensitizer may be bound to the binder material and/or the photoactive material. Examples of suitable photoacid generators include, but are not intended to be limited to, cationic photoinitiators such as diazonium, sulfonium, phosphonium and iodonium salts. In particular, alkoxyphenyl phenyliodonium salts, such as p-octyloxyphenyl phenyliodonium hexafluoroantimonate, ditolyliodonium tetrakis(pentafluorophenyl) borate, diphenyliodonium tetrakis(pentafluorophenyl) borate, tolylphenyliodonium tetrakis(pentafluorophenyl) borate, cumyltolyliodonium tetrakis(pentafluorophenyl) borate, and combinations comprising one or more of the foregoing photoinitiators may be desirable. These salts absorb predominantly in the UV portion of the spectrum, and are therefore generally sensitized to allow use of the visible portion of the spectrum. An example of a visible cationic photoinitiator is (η-6-2,4-cyclopentadien-1-yl) (η-6-isopropylbenzene)-iron(II) hexafluorophosphate, available commercially from Ciba as IRGACURE 261®, which may be employed alone or in combination with any of the foregoing photoinitiators. Another suitable photoinitiator is bis(η-5-2,4-cyclopentadien-1-yl)bis[-2,6-difluoro-3-1H-pyrrol-1-ylphenyl]titanium available as IRGACURE 784® available from Ciba.

In the absence of a sensitizer, iodonium salts are typically sensitive to radiation in the far UV, below about 300 nm, and the use of far UV radiation is inconvenient for the production of holograms because, for a given level of performance, UV lasers are substantially more expensive than visible lasers. However, it is well known that, by the addition of various sensitizers, iodonium salts can be made sensitive to various wavelengths of radiation to which the salts are not substantially sensitive in the absence of the sensitizer. In particular, iodonium salts can be sensitized to visible radiation with sensitizers using certain aromatic hydrocarbons, a specific sensitizer of this type being 5,12-bis(phenylethynyl)naphthacene. This sensitizer renders iodonium salts sensitive to 514 nm radiation from an argon ion laser, and to 532 nm radiation from a frequency-doubled YAG laser, both of which are suitable sources for the production of holograms.

Where the photoactive material is not polymerized by acid catalysis, a variety of other types of photoinitiators known to those skilled in the art and available commercially are suitable for polymerization. To avoid the need for sensitizers, a photoinitiator can be employed that is sensitive to light in the visible part of the spectrum, particularly at wavelengths available from commercially available laser sources, e.g., the blue and green lines of Ar+ (458, 488, 514 nm), He—Cd lasers (442 nm), the green line of frequency doubled YAG lasers (532 nm), the red lines of He—Ne (633 nm), and Kr+ lasers (647 and 676 nm). For example, bis(η-5-2,4-cyclopentadien-1-yl)bis[2,6-difluoro-3-(1H-pyrrol-1-yl)phenyl]titanium, available commercially from Ciba as CGI-784, can be used. Another visible free-radical photoinitiator (which requires a co-initiator) is 5,7,diiodo-3-butoxy-6-fluorone, commercially available from Spectra Group Limited as H-Nu 470.

The proportions of photoinitiator, binder material, photoactive material, and optional binder curing catalyst and/or sensitizer in the holographic storage medium may vary rather widely, and the optimum proportions for specific components and methods of use can readily be determined empirically by those skilled in the art without undue experimentation. However, in some embodiments the holographic storage medium comprises from about 1 percent to about 10 percent by weight of the photoinitiator, about 10 to about 89 percent by weight of the binder material, and about 10 to about 89 percent by weight of the photoactive material, wherein the weight percents are based on the weight of the total medium composition. Optionally, the holographic storage medium may further comprise about 0.01 to about 2 percent by weight of the binder curing catalyst and about 0.1 to about 10 percent by weight of the sensitizer.

The holographic storage medium formed herein may be obtained in the form of an dimensionally stable film. This dimensionally stable film may further be stored and used as such for data storage and retrieval purposes. The dimensionally stable film may optionally be at least partially encapsulated within a transparent substrate. The phrase “transparent substrate” refers to a material that is transparent to radiation in the wavelength in the range of from about 300 nanometers to about 900 nanometers. The phrase “partially encapsulated” refers to the film being fully covered on one side, or partly covered on one side, or fully covered on both sides, or partly covered on either side, or combinations thereof, but not entirely encapsulated on both sides and all edges. Furthermore, the substrate may comprise one or multiple layers of the transparent substrate on one or both sides of the dimensionally stable film. Fabrication of the storage medium may involve depositing the dimensionally stable film onto the substrate. The application of a surface adhesive layer on the substrate or on the film to enhance adhesion between the two components is within the scope of the invention. The substrates may comprise glass, polycarbonates, polyesters, polyamides, polyolefins, or combinations thereof. A stratified medium, i.e., a medium containing multiple supports, e.g., glass, with layers of storage material disposed between the supports, may also be used. Another embodiment of the invention is an article comprising a holographic storage medium that is at least partially encapsulated by a transparent substrate, wherein said holographic storage medium and transparent substrate are optionally joined by an adhesive layer.

In another embodiment the invention relates to a holographic storage medium comprising either an uncured mixture or a partially cured mixture which is not dimensionally stable, said mixture comprising: a binder material; a curable photoactive material; an optional sensitizer; and a photoinitiator, wherein said mixture is at least partially encapsulated within a transparent substrate, and wherein the terms transparent substrate and partially encapsulated are as defined herein above. In still another embodiment the invention relates to an article comprising a transparent mold and a holographic storage medium comprising an uncured mixture or a partially cured mixture which is not dimensionally stable, wherein said holographic storage medium is contained within said transparent mold, said mixture comprising (a) a binder material; (b) a curable photoactive material; (c) an optional sensitizer; and (d) a photoinitiator. In a particular embodiment said uncured mixture or partially cured mixture which is not dimensionally stable is sealed within said mold, wherein the term “mold” is as defined herein below. Said article may be stored and/or shipped before further processing and use. Additionally, further processing of the article may take place, such as, but not limited to, application to the transparent mold of hard coats, anti-reflective coatings, cosmetic applications such as colors or labels, and like processes.

In another embodiment the dimensionally stable film may be formed inside a transparent mold. Thus, in another embodiment the invention comprises an article comprising a holographic storage medium in the form of a dimensionally stable film contained within a transparent mold. In a particular embodiment said dimensionally stable film is sealed within said mold. A “mold”, as used herein, is a device that is used to give shape to the film being formed. A transparent mold comprises a material that is transparent to radiation in the wavelength in the range of from about 300 nanometers to about 900 nanometers. Typically, a mold comprises a recessed area or cavity of a definite geometry which is filled with a flowable, substantially liquid formulation that is used to form the film. Also, the mold is made of a material that is inert to the conditions used to form the film. In some embodiments, the dimensionally stable film formed inside the mold is capable of being removed. The transparent mold comprises glass, polycarbonates, polyesters, polyamides, polyolefins, or combinations thereof. When said mold comprises a thermoplastic material, the mold may be formed by injection molding, blow molding, or like processes. Said article may be stored and/or shipped before further processing and use. Additionally, further processing of the article may take place, such as, but not limited to, application of hard coats, anti-reflective coatings, cosmetic applications such as colors or labels, and like processes.

In an alternate embodiment, the uncured mixture comprising (a) a binder material; (b) a curable photoactive material; (c) an optional sensitizer; and (d) a photoinitiator is made available in a sealed transparent prefabricated mold, wherein the term transparent refers to a material that is transparent to radiation in the wavelength in the range of from about 300 nanometers to about 900 nanometers. Thus, another embodiment of the invention is article comprising: a prefabricated transparent mold and a holographic storage medium comprising said uncured mixture. A “prefabricated mold”, as used herein, is a mold which comprises a recessed area or a cavity, and further comprises an orifice leading to the cavity through which the uncured mixture may be added into the prefabricated mold. The uncured mixture may be added through the orifice of the transparent prefabricated mold using techniques known to those skilled in the art, such as injection. Subsequently, the orifice of the transparent prefabricated mold is sealed using methods known to those skilled in the art, such as by spot curing, by employing an external cover with an adhesive material, and like methods. The curing step may then be performed to form the dimensionally stable film inside of the prefabricated mold. The film along with the transparent mold then serves as the article, wherein the film serves as the holographic storage medium. One or more exterior surfaces of the transparent mold may be further processed for application of a hard coat, an anti-reflective coating, a cosmetic application such as a color or a label, and like applications.

The holographic storage medium thus formed is typically of a thickness within the range of from about 0.01 millimeters to about 10 millimeters, more preferably in the range of from about 0.1 millimeters to about 5.0 millimeters. The encapsulating transparent substrate or the transparent mold, when present, may increase the thickness of the holographic storage medium to the necessary extent, without affecting the data storage capabilities of the holographic storage medium.

The dimensionally stable film may further be subjected to surface treatments. Such surface treatments may be for cosmetic purposes or protective purposes. Suitable examples of cosmetic surface treatments may include, but are not limited to, coloration, anti-reflective coatings, marking, copy protection or labeling. Suitable examples of protective surface treatments may include, but are not limited to, scratch resistant hard coats, solvent resistant coatings, auxiliary layers, light blocking layers, and the like.

Optional additives that enhance appearance may also be added to the formulation before or after the curing step, wherever appropriate. Illustrative examples of optional additives comprise adhesion promoters, absorptive materials, polarizers, expansion agents, thermal stabilizers, defoamers, and like materials.

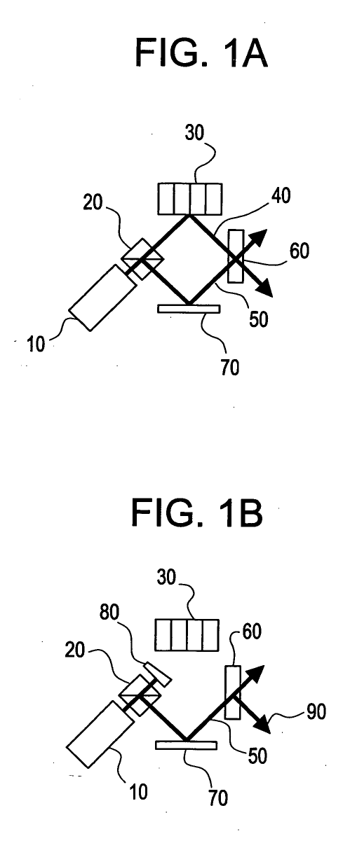

An example of a suitable holographic data storage process is set forth in FIG. 1a. In this configuration the output from a laser 10 is divided into two equal beams by beam splitter 20. One beam, the signal beam 40, is incident on a form of spatial light modulator (SLM) or deformable mirror device (DMD) 30, which imposes the data to be stored in signal beam 40. This device is composed of a number of pixels that can block or transmit the light based upon input electrical signals. Each pixel can represent a bit or a part of a bit (a single bit may consume more than one pixel of the SLM or DMD 30) of data to be stored. The output of SLM or DMD 30 is then incident on the storage medium 60. The second beam, the reference beam 50, is transmitted all the way to storage medium 60 by reflection off first mirror 70 with minimal distortion. The two beams are coincident on the same area of storage medium 60 at different angles. The net result is that the two beams create an interference pattern at their intersection in the storage medium 60. The interference pattern is a unique function of the data imparted to signal beam 40 by SLM or DMD 30. At least a portion of the photoactive material undergoes polymerization, which leads to a modification of the refractive index in the region exposed to the laser light and fixes the interference pattern, effectively creating a grating in the storage medium 60. For reading the data, as depicted in FIG. 1b, the grating or pattern created in storage medium 60 is simply exposed to reference beam 50 in the absence of signal beam 40 by blocking signal beam 40 with a shutter 80 and the data is reconstructed in a recreated signal beam 90.

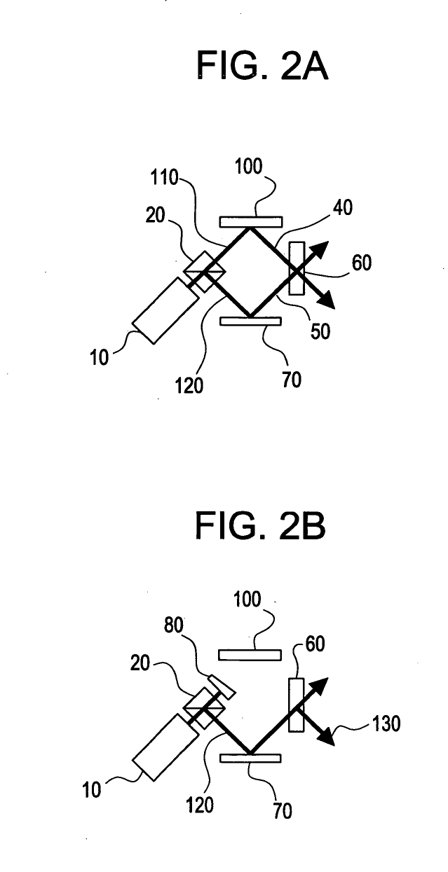

In order to test the characteristics of the material a diffraction efficiency measurement can be used. A suitable system for these measurements is shown in FIG. 2a. This setup is very similar to the holographic storage setup; however, there is no SLM or DMD, but instead, a second mirror 100. The laser 10 is split into two beams 110 and 120 that are then interfered in storage medium 60 creating a plane wave grating. As depicted in FIG. 2b, one of the beams is then turned off or blocked with shutter 80 and the amount of light diffracted by the grating in storage medium 60 is measured. The diffraction efficiency is measured as the power in diffracted beam 130 versus the amount of total power incident on storage medium 60. More accurate measurements may also take into account losses in storage medium 60 resulting from reflections at its surfaces and/or absorption within its volume.

The holographic storage medium may be utilized in conjunction with a process whereby light of one wavelength from a laser is utilized to write the data into the holographic storage medium, while light of the same or a different wavelength is utilized to read the data. For the holographic storage media of the present disclosure, a refractive index change is created by using a writing laser wavelength that induces selective photopolymerization of the photoactive material. Thus, the wavelength employed for writing the data may be a function of the specific photoactive material used.

Once all data has been written onto the holographic storage medium, a larger, broad area of the storage medium may be exposed to a wavelength of light suitable to react with the remaining unreacted photoinitiator and then polymerize any remaining unreacted photoactive material. The broad area may be larger than the size of stored holograms to the size of the entire storage medium. This photocuring step can minimize movement of the components of the storage medium. The method may thus further comprise exposing at least a portion of the storage medium having an area larger than the hologram to a wavelength of light sufficient to react any unreacted photoinitiator and to polymerize any unreacted photoactive material.

As one skilled in the art will appreciate, different molecules will have widely differing absorption profiles (broader, narrower, etc.). Thus, the wavelengths utilized for writing and reading the holographic storage media of the present disclosure will depend upon the light source, the photoinitiator, and the specific photoactive material. Wavelengths suitable for writing data into the holographic storage media may vary, and can be about 375 nm to about 830 nm. In another embodiment, the wavelength for writing data is about 400 nm to about 550 nm. The reading wavelength may be the same as, or different from, the writing wavelength. In one embodiment, the reading and writing wavelengths are the same.

In some embodiments the reading wavelength and the writing wavelength may be about 375 nm to about 830 nm. In other embodiments, the wavelength of light used for writing can be about 400 nm to about 550 nm, and the reading wavelength can be about 600 nm to about 700 nm. In yet another embodiment, a wavelength of 532 nm light can be used for writing and wavelengths of either 633 nm or 650 nm light can be used for reading. Alternatively, read and write wavelengths may be 532 nm and 405 nm, respectively. The holographic storage media as described herein can also be used to store multiplexed holographic data.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples the photoinitiator was bis (n-dodecylphenyl) iodonium hexafluoroantimonate (UV-9380c) obtained from GE Silicones, Waterford, N.Y. The epoxide employed was the bis-epoxide, [bis-2(3,4-epoxycyclohexylethyl)-1,3-tetramethyldisiloxane] (PC-1000) obtained Polyset, Inc., Mechanicsville, N.Y. Polymethylphenylsiloxane was obtained from Gelest, Inc., Morrisville, Pa.

### EXAMPLE 1

A sensitizer solution comprising 10 milligrams (mg) of 5,12-bis(phenylethynyl)naphthacene in 10 milliliters (mL) of bis-epoxide PC-1000 was prepared, allowed to sit for 24 hours (hrs), and filtered through glass wool. A mixture comprising 2 mL of sensitizer solution, 1 mL of vinyl-terminated polymethylphenylsiloxane, and 2 drops of photoinitiator UV-9380c was mechanically mixed in a vial that was covered with aluminum foil. A thin film approximately 0.260 millimeters (mm) thick of this mixture was spread onto a glass slide and exposed to ultraviolet light for 1.5 seconds. The film was removed from the glass slide and cut with a razor blade into approximately 2 centimeter (cm)×2 cm pieces. A single piece of the film was placed on a glass slide using several drops of an adhesive solution on each side of the film. This adhesive solution was made of 8 mL of vinyl-terminated polymethylphenylsiloxane, 1 drop of platinum(0) 1,3-divinyltetramethyldisiloxane, and 32 drops of hydromethylsiloxane:methylphenylsiloxane copolymer. Plastic spacers that were 0.260 mm thick were placed on the slide to control media thickness. A second glass slide was used to cover the film. The sample was heated at 70° C. for 2 minutes (min) per side, and the resulting films were wrapped in foil until tested. Testing involved writing a plane wave hologram through the volume of the film and measuring the diffraction efficiency of the resulting hologram. A diffraction efficiency of 24% was observed.

### EXAMPLE 2

A solution comprising 4 mL of bisepoxide PC-1000, 5.6 mg of 5,12-bis(phenylethynyl)naphthacene, 2 mL of vinyl-terminated polymethylphenylsiloxane, and four drops of photoinitiator UV-9380c was prepared. A sample was prepared by pouring 1 mL of this solution into a mold. The mold consisted of a plastic O-ring lightly glued to a glass slide. A second glass slide was used to cover the open mold. The solution was cured for 4 seconds using a Xenon UV curing system with a B type bulb positioned about 7.6 centimeters above the sample. The sample was flipped over and cured another 4 seconds from the other side. After curing, the sample was removed from the mold and wrapped in foil until tested A plane wave hologram was recorded into the media, with a diffraction efficiency of 3.7%.

### EXAMPLE 3

A mixture comprising (i) 5,12-bis(phenylethynyl)naphthacene; (ii) bis-epoxide PC-1000; (iii) photoinitiator UV-9380c; (iv) platinum(0) 1,3-divinyltetramethyldisiloxane, (v) vinyl-terminated polymethylphenylsiloxane, and (vi) hydromethylsiloxane: methylphenylsiloxane copolymer is mixed in a vial. A thin film of this mixture is spread onto a glass slide and exposed heat-treated for a period of time sufficient to at least partially cure the siloxane components. The film is removed from the glass slide and cut with a razor blade into pieces. A single piece of the film is placed on a glass slide, optionally using several drops of an adhesive solution on each side of the film. Plastic spacers are placed on the slide to control media thickness. A second glass slide is used to cover the film. If the sample comprises an adhesive, then it is heated to effect curing of the adhesive. Testing involves writing a plane wave hologram through the volume of the film and measuring the diffraction efficiency of the resulting hologram. A hologram could be written satisfactorily to the film.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A method of making a holographic storage medium comprising an dimensionally stable film, said method comprising:
forming said dimensionally stable film by partially curing a mixture,
wherein said mixture comprises
a binder material;
a curable photoactive material;
an optional sensitizer; and
a photoinitiator,
and wherein at least a portion of the photoactive material remains unreacted after the forming of the holographic storage medium.

2. The method of claim 1, wherein the binder material comprises an inert material, a reaction product of a thermally curable mixture comprising at least one curable monomer, or combinations thereof.

3. The method of claim 1, wherein the binder material comprises a poly(dialkylsiloxane); a poly(alkylarylsiloxane); a poly(methylphenylsiloxane); 1,3,5-trimethyl-1,1,3,5,5-pentaphenyltrisiloxane; an alkenyl-functionalized polysiloxane; a vinyl-terminated poly(dialkylsiloxane); a vinyl-terminated poly(alkylarylsiloxane); a vinyl-terminated poly(methylphenylsiloxane); a reaction product of a hydride-functionalized polysiloxane and an alkenyl-functionalized polysiloxane; a cyclic silicone oligomer; a product derived from a cyclic silicone oligomer; a product derived from divinyltetramethyldisiloxane; or combinations thereof.

4. The method of claim 1, wherein the binder material is derived from vinyl-terminated poly(methylphenylsiloxane).

5. The method of claim 1, wherein the photoactive material comprises a vinyl ether, an alkenyl ether, an allene ether, a ketene acetal, an epoxide, an acrylate, a methacrylate, a methyl methacrylate, an acrylamide, a methacrylamide, a styrene, a substituted styrene, a vinyl naphthalene, a substituted vinyl naphthalene, a vinyl derivative, a maleate, a thiol, an olefin, or combinations comprising at least one of the foregoing photoactive materials.

6. The method of claim 1, wherein the photoactive material comprises cyclohexene oxide, cyclopentene oxide, 4-vinyl cyclohexene oxide, a 4-alkoxymethylcyclohexene oxide, a acyloxymethylcyclohexene oxide, 3,4-epoxycyclohexylmethyl-3,4-epoxycyclohexanecarboxylate, 1,3-bis(2-(3,4-epoxycyclohexyl)ethyl)-1,1,3,3-tetramethydisiloxane, 2-epoxy-1,2,3,4-tetrahydronaphthalene; a derivative capable of being prepared from any of the foregoing epoxides; or combinations comprising one of the foregoing epoxides.

7. The method of claim 1, wherein the photoactive material is selected from the group consisting of (a) epoxide compounds represented by formula (II): 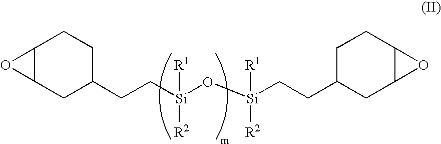
wherein each R¹ and each R² is independently a C₁₋₁₂ aliphatic group, C₁₋₁₂ cycloaliphatic or C₃-C₂₀ aromatic radical; and m is an integer ranging from 1 to 100;
(b) epoxide compounds represented by formula (III): 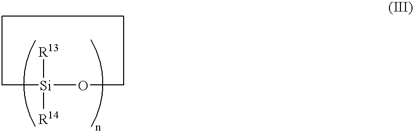
wherein each R¹³ is independently a monovalent substituted or unsubstituted C₁₋₁₂ aliphatic, C₁₋₁₂ cycloaliphatic, or C₃-C₂₀ aromatic group; each R¹⁴ is, independently, R¹³ or a monovalent epoxy functional group having 2 to 10 carbon atoms, with the proviso that at least three of the R¹⁴ groups are epoxy functional; and n is 3 to 10;
(c) epoxide compounds represented by:
R⁴Si(OSi(R⁵)₂R⁶)₃
wherein R⁴ is an OSi(R⁵)₂R⁶ grouping, or a monovalent substituted or unsubstituted C₁₋₁₂ aliphatic, C₁₋₁₂ cycloaliphatic, or C₃-C₂₀ aromatic group; each R⁵ is independently a monovalent substituted or unsubstituted C₁₋₁₂ aliphatic, C₁₋₁₂ cycloaliphatic, or C₃-C₂₀ aromatic group; and each R⁶ is independently a monovalent epoxy functional group having 2 to 10 carbon atoms;
(d) epoxide compounds represented by:
(R⁷)₃SiO[SiR⁸R⁹O]ₚ[Si(R⁸)₂O]_{q}Si(R⁷)₃
wherein each R⁷ is independently a monovalent substituted or unsubstituted C₁₋₁₂ aliphatic, C₁₋₁₂ cycloaliphatic, or C₃-C₂₀ aromatic group; each R⁸ is independently a monovalent substituted or unsubstituted C₁₋₁₂ aliphatic, C₁₋₁₂ cycloaliphatic, or C₃-C₂₀ aromatic group; each R⁹ is independently a monovalent epoxy functional group having 2 to 10 carbon atoms; p is an integer having a value in a range of between about 1 and about 20; and q is an integer having a value in a range of between about 5 and about 200;
(e) epoxide compounds represented by:
R⁹(R⁷)₂SiO[SiR⁸R⁹O]ₚ[Si(R⁸)₂O]_{q}Si(R⁷)₂R⁹
wherein each R⁷ is, independently, a monovalent substituted or unsubstituted C₁₋₁₂ aliphatic, C₁₋₁₂ cycloaliphatic, or C₃-C₂₀ aromatic group; each R⁸ is, independently, a monovalent substituted or unsubstituted C₁₋₁₂ aliphatic, C₁₋₁₂ cycloaliphatic, or C₃-C₂₀ aromatic group; each R⁹ is, independently, a monovalent epoxy functional group having 2 to 10 carbon atoms; p is an integer having a value in a range of between about 1 and about 20; and q is an integer having a value in a range of between about 5 and about 200; and
(f) combinations of any of the aforementioned epoxy compounds.

8. The method of claim 1, wherein the photoinitiator comprises p-octyloxyphenyl phenyliodonium hexafluoroantimonate, ditolyliodonium tetrakis(pentafluorophenyl) borate, diphenyliodonium tetrakis(pentafluorophenyl)borate, tetrakis(pentafluorophenyl)borate, cumyltolyliodonium tetrakis(pentafluorophenyl)borate, (η-6-2,4-cyclopentadien-1-yl) (η-6-isopropylbenzene)-iron(II) hexafluorophosphate, bis(η-5-2,4-cyclopentadien-1-yl) bis[2,6-difluoro-3-(1H-pyrrol-1-yl)phenyl]titanium, 5,7-diiodo-3-butoxy-6-fluorone, or a combination comprising at least one of the foregoing photoinitiators.

9. The method of claim 1, wherein the curing step comprises UV curing, or thermal curing of a thermally curable binder material which comprises at least one alkenylsiloxane compound, at least one hydrosiloxane compound, and a thermal curing catalyst in an amount effective to initiate or promote thermal curing.

10. The method of claim 1, wherein the sensitizer is present.

11. The method of claim 10, wherein the sensitizer is selected from the group consisting of rubrene, 5,12-bis(phenylethynyl)naphthacene, perylene, N-vinyl carbazole, N-phenyl carbazole, and combinations thereof.

12. The method of claim 1, wherein (a) the curing step to form said dimensionally stable film is performed inside a transparent mold, followed by removing the dimensionally stable film from the mold, or wherein (b) the curing step takes place within a sealed transparent mold, or wherein (c) the dimensionally stable film obtained after a separate curing step may be at least partially encapsulated by a substrate; wherein said dimensionally stable film and said substrate are optionally joined by an adhesive layer;
wherein said transparent mold and substrate are transparent to radiation of wavelength in the range of from about 300 nanometers to about 900 nanometers, and wherein said transparent mold and substrate are selected from the group consisting of glass, polycarbonates, polyesters, polyamides, polyolefins, and combinations thereof.

13. The method of claim 1, wherein the dimensionally stable film is of a thickness in the range of from about 0.1 millimeters to about 10 millimeters.

14. A holographic storage medium made by the method of claim 1.

15. An article comprising a sealed transparent mold and the holographic storage medium of claim 14.

16. An article comprising the holographic storage medium of claim 14 at least partially encapsulated by a transparent substrate, wherein said holographic storage medium and transparent substrate are optionally joined by at least one adhesive layer.

17. A holographic storage medium comprising:
a dimensionally stable film, said dimensionally stable film of said holographic storage medium comprising
a binder material;
an unreacted curable photoactive material;
an optional sensitizer; and
a photoinitiator.

18. The holographic storage medium of claim 17, wherein the dimensionally stable film is subsequently written with holographic interference pattern.

19. The holographic storage medium of claim 17, wherein the binder material comprises an inert material, a reaction product of a thermally curable mixture comprising at least one curable monomer, or combinations thereof.

20. The holographic storage medium of claim 17, wherein the binder material comprises a poly(dialkylsiloxane); a poly(alkylarylsiloxane); a poly(methylphenylsiloxane); 1,3,5-trimethyl-1,1,3,5,5-pentaphenyltrisiloxane; an alkenyl-functionalized polysiloxane; a vinyl-terminated poly(dialkylsiloxane); a vinyl-terminated poly(alkylarylsiloxane); a vinyl-terminated poly(methylphenylsiloxane); a reaction product of a hydride-functionalized polysiloxane and an alkenyl-functionalized polysiloxane; a cyclic silicone oligomer; a product derived from a cyclic silicone oligomer; a product derived from divinyltetramethyldisiloxane; or combinations thereof.

21. The holographic storage medium of claim 17, wherein the binder material is derived from vinyl-terminated poly(methylphenylsiloxane).

22. The holographic storage medium of claim 17, wherein the photoactive material comprises a vinyl ether, an alkenyl ether, an allene ether, a ketene acetal, an epoxide, an acrylate, a methacrylate, a methyl methacrylate, an acrylamide, a methacrylamide, a styrene, a substituted styrene, a vinyl naphthalene, a substituted vinyl naphthalene, a vinyl derivative, a maleate, a thiol, an olefin, or combinations comprising at least one of the foregoing photoactive materials.

23. The holographic storage medium of claim 17, wherein the photoactive material comprises cyclohexene oxide; cyclopentene oxide, 4-vinyl cyclohexene oxide, a 4-alkoxymethylcyclohexene oxide, a acyloxymethylcyclohexene oxide, 3,4-epoxycyclohexylmethyl-3,4-epoxycyclohexanecarboxylate, 1,3-bis(2-(3,4-epoxycyclohexyl)ethyl)-1,1,3,3-tetramethydisiloxane, 2-epoxy-1,2,3,4-tetrahydronaphthalene; a derivative of being prepared from any of the foregoing epoxides; or combinations comprising one of the foregoing epoxides.

24. The holographic storage medium of claim 17, wherein the photoactive material is selected from the group consisting of (a) epoxide compounds represented by formula (II): 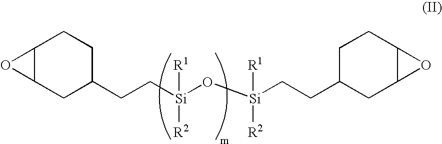
wherein each R¹ and each R² is independently a C₁₋₁₂ aliphatic group, C₁₋₁₂ cycloaliphatic or C₃-C₂₀ aromatic radical; and m is an integer ranging from 1 to 100;
(b) epoxide compounds represented by formula (III): 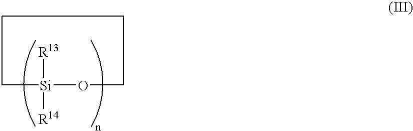
wherein each R¹³ is independently a monovalent substituted or unsubstituted C₁₋₁₂ aliphatic, C₁₋₁₂ cycloaliphatic, or C₃-C₂₀ aromatic group; each R¹⁴ is independently R¹³ or a monovalent epoxy functional group having 2 to 10 carbon atoms, with the proviso that at least three of the R¹⁴ groups are epoxy functional; and n is 3 to 10;
(c) epoxide compounds represented by:
R⁴Si(OSi(R⁵)₂R⁶)₃
wherein R⁴ is an OSi(R⁵)₂R⁶ grouping, or a monovalent substituted or unsubstituted C₁₋₁₂ aliphatic, C₁₋₁₂ cycloaliphatic, or C₃-C₂₀ aromatic group; each R⁵ is, independently, a monovalent substituted or unsubstituted C₁₋₁₂ aliphatic, C₁₋₁₂ cycloaliphatic, or C₃-C₂₀ aromatic group; and each R⁶ is, independently, a monovalent epoxy functional group having 2 to 10 carbon atoms;
(d) epoxide compounds represented by:
(R⁷)₃SiO[SiR⁸R⁹O]ₚ[Si(R⁸)₂O]_{q}Si(R⁷)₃
wherein each R⁷ is, independently, a monovalent substituted or unsubstituted C₁₋₁₂ aliphatic, C₁₋₁₂ cycloaliphatic, or C₃-C₂₀ aromatic group; each R⁸ is, independently, a monovalent substituted or unsubstituted C₁₋₁₂ aliphatic, C₁₋₁₂ cycloaliphatic, or C₃-C₂₀ aromatic group; each R⁹ is, independently, a monovalent epoxy functional group having 2 to 10 carbon atoms; p is an integer having a value in a range of between about 1 and about 20; and q is an :integer having a value in a range of between about 5 and about 200;
(e) epoxide compounds represented by:
R⁹(R⁷)₂SiO[SiR⁸R⁹O]ₚ[Si(R⁸)₂O]_{q}Si(R⁷)₂R⁹
wherein each R⁷ is, independently, a monovalent substituted or unsubstituted C₁₋₁₂ aliphatic, C₁₋₁₂ cycloaliphatic, or C₃-C₂₀ aromatic group; each R⁸ is, independently, a monovalent substituted or unsubstituted C₁₋₁₂ aliphatic, C₁₋₁₂ cycloaliphatic, or C₃-C₂₀ aromatic group; each R⁹ is, independently, a monovalent epoxy functional group having 2 to 10 carbon atoms; p is an integer having a value in a range of between about 1 and about 20; and q is an integer having a value in a range of between about 5 and about 200; and
(f) combinations of any of the aforementioned epoxy compounds.

25. The holographic storage medium of claim 17, wherein the photoinitiator comprises p-octyloxyphenyl phenyliodonium hexafluoroantimonate, ditolyliodonium tetrakis(pentafluorophenyl) borate, diphenyliodonium tetrakis(pentafluorophenyl)borate, tetrakis(pentafluorophenyl)borate, cumyltolyliodonium tetrakis(pentafluorophenyl)borate, (η-6-2,4-cyclopentadien-1-yl) (η-6-isopropylbenzene)-iron(II) hexafluorophosphate, bis(η-5-2,4-cyclopentadien-1-yl) bis[2,6-difluoro-3-(1H-pyrrol-1-yl)phenyl]titanium, 5,7-diiodo-3-butoxy-6-fluorone, or a combination comprising at least one of the foregoing photoinitiators.

26. The holographic storage medium of claim 17, wherein the dimensionally stable film is of a thickness in the range of from about 0.1 millimeters to about 10 millimeters.

27. The holographic storage medium of claim 17, wherein the sensitizer is present.

28. The holographic storage medium of claim 27, wherein the sensitizer is selected from the group consisting of rubrene, 5,12-bis(phenylethynyl)naphthacene, perylene, N-vinyl carbazole, N-phenyl carbazole, and combinations thereof.

29. A holographic storage medium comprising a dimensionally stable film, wherein (a) the dimensionally stable film is in a sealed transparent mold, or (b) is partially encapsulated by a substrate, wherein said dimensionally stable film and said substrate are optionally joined by an adhesive layer;
wherein said transparent mold and said substrate are transparent to radiation of wavelength in the range of from about 300 nanometers to about 900 nanometers, and wherein said transparent mold and said substrate are selected from the group consisting of glass, polycarbonates, polyesters, polyamides, polyolefins, and combinations thereof.

30. A method of storing data on a holographic storage medium comprising the steps of:
(i) forming the holographic storage medium in the form of an dimensionally stable film, said dimensionally stable film formed by partially curing a mixture, said mixture comprising:
a binder material;
a curable photoactive material;
an optional sensitizer;
a photoinitiator, and
an optional thermal curing catalyst;
wherein at least a portion of the photoactive material remains after the partial cure process;
wherein the binder material comprises either an inert material; a reaction product of a thermally curable mixture comprising at least one curable monomer; or combinations thereof;
wherein the photoactive material comprises one or more epoxide compounds;
wherein (a) the curing step to form said dimensionally stable film is performed inside a transparent mold, followed by removing the dimensionally stable film from the mold, or wherein (b) the curing step takes place within a sealed transparent mold, or wherein (c) the dimensionally stable film obtained after a separate curing step may be at least partially encapsulated by a substrate; wherein said dimensionally stable film and said substrate are optionally joined by an adhesive layer; wherein said transparent mold and substrate are transparent to radiation of wavelength in the range of from about 300 nanometers to about 900 nanometers, and wherein said transparent mold and substrate are selected from the group consisting of glass, polycarbonates, polyesters, polyamides, polyolefins, and combinations thereof; and
(ii) illuminating the holographic storage medium with both a signal beam containing data and a reference beam, thereby forming within the holographic storage medium an interference pattern, wherein the photoinitiator initiates polymerization of at least a portion of the photoactive material in response to the signal beam and reference beam, resulting in formation of a hologram in the holographic storage medium.

31. The method of claim 30, wherein the signal beam has a wavelength of about 375 nm to about 830 nm.

32. The method of claim 30, further comprising the step of exposing at least a portion of the storage medium having an area larger than the hologram to a wavelength of light sufficient to polymerize any unreacted photoactive material.

33. An optical reading method comprising:
(i) forming a holographic storage medium comprising an dimensionally stable film, said dimensionally stable film formed by partially curing a mixture, said mixture comprising:
a binder material;
a curable photoactive material;
an optional sensitizer;
a photoinitiator, and
an optional thermal curing catalyst;
wherein at least a portion of the photoactive material remains after the partial cure process;
wherein the binder material comprises an inert material; a reaction product of a thermally curable mixture comprising at least one curable monomer; or combinations thereof;
wherein the photoactive material comprises one or more epoxide compounds;
wherein (a) the curing step to form said dimensionally stable film is performed inside a transparent mold, followed by removing the dimensionally stable film from the mold, or wherein (b) the curing step takes place within a sealed transparent mold, or wherein (c) the dimensionally stable film obtained after the curing step may be at least partially encapsulated by a substrate, wherein said dimensionally stable film and said substrate are optionally joined by an adhesive layer; wherein said transparent mold and substrate are transparent to radiation of wavelength in the range of from about 300 nanometers to about 900 nanometers, and wherein said transparent mold and substrate are selected from the group consisting of glass, polycarbonates, polyesters, polyamides, polyolefins, and combinations thereof;
(ii) illuminating the holographic storage medium with both a signal beam containing data and a reference beam, thereby forming within the holographic storage medium an interference pattern, wherein the photoinitiator initiates polymerization of at least a portion of the photoactive material, resulting in formation of a hologram in the holographic storage medium; and
(iii) illuminating the holographic storage medium with a read beam effective to read the data contained by diffracted light from the hologram.

34. The method of claim 33, wherein the signal beam has a wavelength of about 375 nm to about 830 nm, and wherein the read beam has a wavelength of about 375 nm to about 830 nm.

35. An article comprising:
a prefabricated transparent mold and a holographic storage medium comprising an uncured mixture,
wherein said holographic storage medium is sealed within said transparent mold, said mixture comprising:
a binder material;
a curable photoactive material;
an optional sensitizer; and
a photoinitiator.
